(19) United States
(12) Patent Application Publication
(10) Pub. No.: US 2022/0040714 A1
(43) Pub. Date: Feb. 10, 2022

(54) Valve

(71) Applicant: ABB Schweiz AG, Baden (CH)

(72) Inventors: Jakob Trydal, Kvernaland (NO); Gunnar Soyland, Bryne (NO); Ole-Morten Larsen, Sandnes (NO); Jose Rodrigues, Bad Homburg Hesse (DE)

(21) Appl. No.: 17/296,304

(22) PCT Filed: Dec. 21, 2018
(86) PCT No.: PCT/EP2018/086534

§ 371 Date: May 24, 2021

(51) Int. Cl. B05B 1/30; F16K 41/00; F16K 31/122; B05B 15/58; B05C 5/02

(52) U.S. Cl. CPC B05B 1/306; F16K 41/003; B05C 5/0237; B05B 15/58; F16K 31/1221

(57) ABSTRACT

A valve for controlling a flow of process fluid, the valve including a housing; a shaft having a closing member, the shaft being received in the housing, and arranged to move axially relative to the housing; an outer seal arrangement for preventing process fluid from entering the housing, the outer seal arrangement including at least one dynamic radial outer seal enclosing the shaft; an inner seal arrangement, axially spaced from the outer seal arrangement along the shaft, the inner seal arrangement including at least one dynamic radial inner seal enclosing the shaft; and a buffer liquid chamber containing buffer liquid, the buffer liquid chamber being configured to provide buffer liquid to the shaft, and being arranged between, and sealingly closed by, the outer seal arrangement and the inner seal arrangement.

### TECHNICAL FIELD

The present disclosure generally relates to a valve. In particular, a valve comprising a buffer liquid chamber between an outer seal arrangement and an inner seal arrangement, is provided.

### BACKGROUND

Modern paint often comprises two components, referred to as resin and catalyst, that are mixed before application. As soon as the components are mixed, the hardening process begins. The catalyst also hardens if it comes in contact with air. Some prior art 2/2 valves (2 way/2 position) comprising one or more dynamic radial seals along a valve shaft tend to fail prematurely when used to control a flow of process fluid comprising catalyst or mixed paint. The radial seals often fail such that process fluid leaks into the valve, which may be manifested by a sticking of the valve shaft in an open or closed position, or by a deteriorated response of the valve shaft.

If the process fluid is pure catalyst, the failure is often caused by particles of catalyst that leak along the valve shaft, past the radial seals, and into a pilot chamber of the valve. In the pilot chamber, the catalyst is exposed to the pilot air and thereby hardens. This increases the friction of the valve shaft.

If the process fluid comprises paint mixed of resin and catalyst, particles of the mixed paint may also leak past the radial seals along the valve shaft, causing a similar problem. In addition, since the hardening process of the paint has already started due to the mixing, small particles of hardened, mixed paint tend to stick to the valve shaft, creating a rough surface thereon. When the valve is operated repeatedly, these particles wear down the radial seals along the valve shaft, and increase leakage beyond the radial seals, such as into a pilot chamber. This eventually leads to failure of the valve.

The problems with valves comprising dynamic radial seals may be solved by using a diaphragm valve. Diaphragm valves have no dynamic seals along the valve needle, which are in contact with the process fluid. However, diaphragm valves have a relatively short lifetime and are bulky.

US 2007120085 A1 discloses a redundant sealing system with secondary containment for preventing leakage of fluid along a valve shaft. The system comprises a first set of dynamic seals, a second set of dynamic seals, an auxiliary barrier fluid chamber, and a barrier fluid indicator.

### SUMMARY

One object of the present disclosure is to provide a valve having an improved sealing.

A further object of the present disclosure is to provide a valve having a reliable operation.

A still further object of the present disclosure is to provide a valve having a simple operation.

A still further object of the present disclosure is to provide a valve having a long lifetime.

A still further object of the present disclosure is to provide a valve having a compact design.

A still further object of the present disclosure is to provide a valve that is cheap.

A still further object of the present disclosure is to provide a valve solving several or all of the foregoing objects in combination.

According to one aspect, there is provided a valve for controlling a flow of process fluid, the valve comprising a housing; a shaft having a closing member, the shaft being received in the housing, and arranged to move axially relative to the housing between a closed position for closing a process fluid passage by means of the closing member, and an open position for opening the process fluid passage by means of the closing member; an outer seal arrangement for preventing process fluid from entering the housing, the outer seal arrangement comprising at least one dynamic radial outer seal enclosing the shaft; an inner seal arrangement, axially spaced from the outer seal arrangement along the shaft, the inner seal arrangement comprising at least one dynamic radial inner seal enclosing the shaft; and a buffer liquid chamber containing buffer liquid, the buffer liquid chamber being configured to provide buffer liquid to the shaft, and being arranged between, and sealingly closed by, the outer seal arrangement and the inner seal arrangement.

The buffer liquid in the buffer liquid chamber forms a buffer between the process fluid and the ambient atmosphere. Thereby, the sealing performance of the valve is improved. The buffer liquid improves the sealing efficiency of the valve, compared to using barrier liquid or radial seals only. The buffer liquid prevents both leakage along the shaft and deposition of hardened particles on the shaft. In addition, the buffer liquid serves as a lubricant for the at least one inner seal of the inner seal arrangement. Consequently, the wear on the inner seal arrangement is reduced and the lifetime of the valve is extended. The buffer liquid may comprise, or be constituted by, a solvent for the process fluid. As used herein, a buffer liquid is preferably unpressurized but may also be pressurized between the atmospheric pressure and the pressure of the process fluid, in contrast to barrier liquid, which is pressurized above the pressure of the process fluid.

The outer seal arrangement may seal between the shaft and the housing. The outer seal arrangement may comprise a plurality of seals arranged in fluidic series, for example a dynamic radial first outer seal and a dynamic radial second outer seal. The first outer seal may for example be a D-ring seal. The second outer seal may for example be a U-cup seal, open towards the closing member and the process fluid passage.

The inner seal arrangement may seal between the shaft and the housing. The inner seal arrangement may comprise a plurality of seals arranged in fluidic series, for example a dynamic radial first inner seal and a dynamic radial second inner seal. Each of the first inner seal and the second inner seal may for example be a U-cup seal. In this case, the first inner seal may be open away from the buffer liquid chamber and the second inner seal may be open towards the buffer liquid chamber.

The buffer liquid chamber may fully or partially enclose the shaft. The shaft may alternatively be referred to as a stem or shaft needle. The shaft may move axially, i.e. translate linearly, along a shaft axis that is constituted by a longitudinal axis of the shaft.

The closing member may be configured to close the process fluid passage by being seated against a valve seat. The closing member may be provided at a distal end of the shaft. The closing member may thus be a plug member or cap. Alternative types of closing members are conceivable.

The valve may be a 2/2 valve (2 way/2 position). The valve according to the present disclosure may constitute a 2/2 valve with buffer liquid as part of a dynamic sealing solution along the shaft. Process fluids according to the present disclosure may be either process liquids or process gases. The valve may be configured to control a flow of process fluids comprising, or being constituted by, solvents.

The buffer liquid chamber may have a fixed volume. The shaft may be the only movable part during operation of the valve that is in connection with the buffer liquid chamber. Movements of the shaft do however not change the volume of the buffer liquid chamber since the shaft extends through the buffer liquid chamber and moves axially.

The buffer liquid may be substantially unpressurized, or unpressurized. For example, the valve may be configured such that a pressure of the buffer liquid during operation of the valve is less than 150 kPa, such as less than 120 kPa.

The valve may further comprise at least one filling opening for filling buffer liquid into the buffer liquid chamber, and an openable closing element for closing the filling opening. An operator may open the closing element, fill the buffer liquid chamber with buffer liquid through the filling opening, and close the filling opening with the closing element. The buffer liquid chamber may then be closed during operation of the valve. The valve may further comprise an additional filling opening and an associated openable closing element for closing the additional filling opening. The additional filling opening may be used to ventilate air when filling buffer liquid into the buffer liquid chamber.

The inner seal arrangement may comprise a dynamic radial first inner seal enclosing the shaft; a dynamic radial second inner seal enclosing the shaft, the second inner seal being arranged to sealingly close the buffer liquid chamber; and a ventilating passage arranged to ventilate a collection volume between the first inner seal and the second inner seal. By ventilating the collection volume, a pressure buildup (e.g. of buffer liquid and/or pilot fluid) between the first inner seal and the second inner seal can be prevented. Such pressure buildup may sometimes cause leakage past the inner seal arrangement. The ventilation of the collection volume improves the performance of the first inner seal and the second inner seal. Furthermore, the performance and lifetime of the valve comprising the ventilating passage and the buffer liquid in combination is significantly improved in comparison with standard 2/2 valves lacking buffer liquid and a pressure venting between dynamic radial seals. The ventilating passage, and hence also the collection volume, may be at atmospheric pressure. The collection volume may partly or fully enclose the shaft.

The ventilating passage may comprise a shaft passage in the shaft. The shaft may thus be hollow. This contributes to a more compact design of the valve. Alternatively, or in addition, the ventilating passage may comprise one or more passages in the housing.

The shaft passage may extend longitudinally to an end of the shaft. Alternatively, or in addition, the shaft passage may extend radially through an exterior surface of the shaft.

The shaft passage may be arranged to be in fluid communication with the collection volume in the closed position, in the open position, and in any intermediate position, of the shaft. Thereby, a continuous ventilation of the collection volume is enabled during operation of the valve.

The ventilating passage may be at atmospheric pressure during operation of the valve. In this way, it can be ensured that the pressure between the first inner seal and the second inner seal never exceeds atmospheric pressure.

The valve may further comprise a distance element arranged to maintain a distance between the first inner seal and the second inner seal. The distance element may be arranged between the first inner seal and the second inner seal, e.g. such that the first inner seal and the second inner seal abut against opposite ends of the distance element. The distance element may for example be a bushing enclosing the shaft.

The collection volume may be defined between the first inner seal and the second inner seal. That is, the collection volume may be axially closed by the first inner seal and the second inner seal. For example, the collection volume may be defined between the first inner seal and the second inner seal along the exterior surface of the shaft.

The valve may further comprise a pilot chamber in the housing, the pilot chamber being arranged to receive pressurized pilot fluid to drive the shaft. The pilot fluid may be pilot air. The valve may be configured such that the shaft adopts the open position when pressurized fluid is supplied to the pilot chamber. The valve may further comprise one or more compression springs arranged to force the shaft back to the closed position when the pressure in the pilot chamber decreases. The pilot chamber may fully or partially enclose the shaft. The shaft may however be driven in other ways than by means of pressurized pilot fluid.

The valve may further comprise a piston fixed to the shaft and a piston seal, and the pilot chamber may be sealingly closed by the inner seal arrangement and the piston seal. Thus, when pressurized pilot fluid enters the pilot chamber, the pressure of the pilot fluid acts on the piston to drive the shaft.

In case the valve comprises a ventilating passage, the inner seal arrangement prevents pilot fluid from entering the collection volume. The inner seal arrangement may thus be provided between the pilot chamber and the buffer liquid chamber along the shaft. In this case, the buffer liquid chamber may be more distal than the inner seal arrangement, i.e. closer to the closing member.

The pilot chamber may be defined between the piston seal and the inner seal arrangement along the exterior surface of the shaft. The pilot chamber may be sealingly closed by the piston seal and by the first inner seal of the inner seal arrangement.

The valve may be configured to control a flow of process fluid comprising paint. In this case, the combination of the ventilating passage and the buffer liquid is particularly advantageous in order to prevent pilot fluid from being mixed with the paint.

According to a further aspect, there is provided a valve block comprising at least one valve according to the present disclosure. According to a further aspect, there is provided a spraying apparatus comprising at least one valve block according to the present disclosure or at least one valve according to the present disclosure.

### BRIEF DESCRIPTION OF THE DRAWINGS

Further details, advantages and aspects of the present disclosure will become apparent from the following embodiments taken in conjunction with the drawings, wherein:

FIG. 1: schematically represents a cross-sectional side view of a valve in a closed position;

FIG. 2: schematically represents a cross-sectional side view of the valve in FIG. 1 in an open position;

FIG. 3: schematically represents a cross-sectional view of a valve block comprising the valve, when the valve is in the closed position; and

FIG. 4: schematically represents a cross-sectional view of the valve block in FIG. 3 when the valve is in the open position.

### DETAILED DESCRIPTION

In the following, a valve comprising a buffer liquid chamber between an outer seal arrangement and an inner seal arrangement, will be described. The same reference numerals will be used to denote the same or similar structural features.

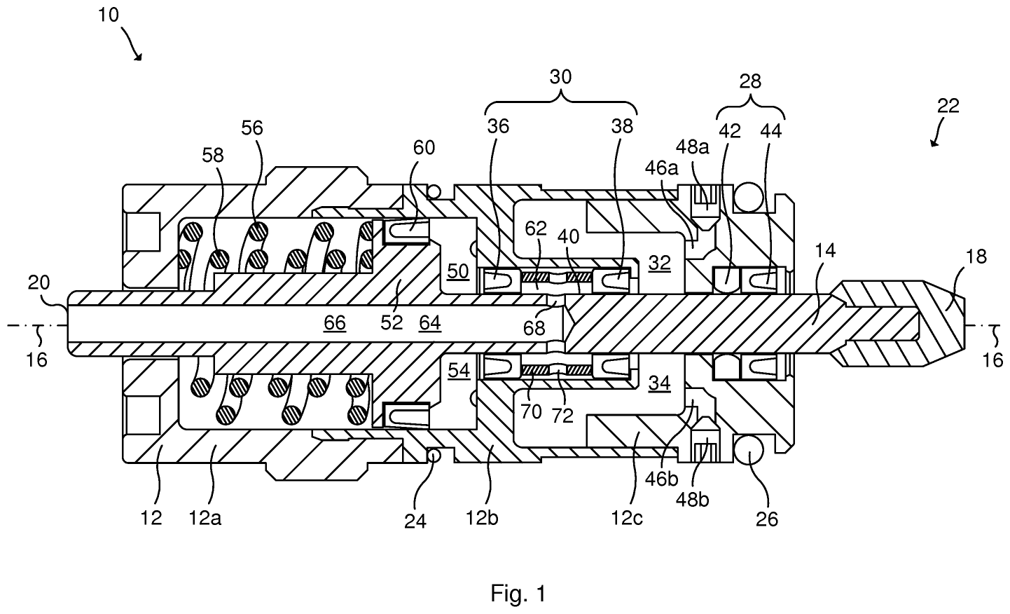

FIG. 1 schematically represents a cross-sectional side view of a valve 10. The valve 10 is configured to control a flow of process fluid. The valve 10 of this example is a 2/2 valve. The valve 10 comprises a housing 12 and a shaft 14 received in the housing 12. The shaft 14 is elongated along a shaft axis 16. The shaft 14 is axially movable relative to the housing 12 along the shaft axis 16.

The shaft 14 comprises a closing member 18. In this example, the closing member 18 is a plug member arranged at the distal end (right end in FIG. 1) of the shaft 14. The shaft 14 also comprises an end 20, at an opposite side with respect to the closing member 18. In FIG. 1, the shaft 14 and the valve 10 are in a closed position 22. In the closed position 22, the shaft 14 can close a process fluid passage by seating the closing member 18 against a valve seat.

The housing 12 of the specific example in FIG. 1 comprises three housing parts 12a, 12b, 12c. The housing parts 12a, 12b, 12c are rigidly connected to form the housing 12 of the valve 10. FIG. 1 further illustrates two exterior O-ring seals 24, 26 for sealing the valve 10 in a valve block.

The valve 10 further comprises an outer seal arrangement 28. The outer seal arrangement 28 seals between the shaft 14 and the housing 12. The outer seal arrangement 28 is thereby configured to prevent process fluid from entering into the housing 12 along the shaft 14.

The valve 10 further comprises an inner seal arrangement 30. The inner seal arrangement 30 seals between the shaft 14 and the housing 12. The inner seal arrangement 30 is axially spaced from the outer seal arrangement 28. The inner seal arrangement 30 is proximal of the outer seal arrangement 28, i.e. further away from the closing member 18.

The valve 10 further comprises a buffer liquid chamber 32. In FIG. 1, the buffer liquid chamber 32 contains unpressurized buffer liquid 34. The buffer liquid 34 may for example comprise Mesamoll® or another softener. The buffer liquid chamber 32 fully encircles the shaft 14. Thereby, the buffer liquid chamber 32 is arranged to provide buffer liquid 34 to the shaft 14.

The buffer liquid chamber 32 is arranged along the shaft 14 between the inner seal arrangement 30 and the outer seal arrangement 28. Moreover, the buffer liquid chamber 32 is sealingly closed by the inner seal arrangement 30 and the outer seal arrangement 28.

The inner seal arrangement 30 of this example comprises a dynamic radial first inner seal 36 and a dynamic radial second inner seal 38. Each of the first inner seal 36 and the second inner seal 38 are provided around an exterior surface 40 of the shaft 14 and encloses the shaft 14. The second inner seal 38 sealingly closes the buffer liquid chamber 32. In the example in FIG. 1, each of the first inner seal 36 and the second inner seal 38 is a U-cup seal. The first inner seal 36 is open away from the buffer liquid chamber 32 and the second inner seal 38 is open towards the buffer liquid chamber 32.

The outer seal arrangement 28 of this example comprises a dynamic radial first outer seal 42 and a dynamic radial second outer seal 44. Each of the first outer seal 42 and the second outer seal 44 are provided around the exterior surface 40 of the shaft 14 and encloses the shaft 14. In the example in FIG. 1, the first outer seal 42 is a D-ring seal and the second outer seal 44 is a U-cup seal, open towards the closing member 18.

The valve 10 further comprises two filling openings 46a, 46b. As shown in FIG. 1, each filling opening 46a, 46b of this example is a passage through the housing 12, more specifically in the housing part 12c, between the buffer liquid chamber 32 and the exterior of the housing 12. The valve 10 further comprises two openable closing elements 48a, 48b closing a respective filling opening 46a, 46b. A user may remove the closing elements 48a, 48b, and fill buffer liquid 34 into the buffer liquid chamber 32 through one of the filling openings 46a, 46b. In this case, the opposite filling opening 46a, 46b facilitates air removal during filling. The opposite filling opening 46a, 46b may be kept open until only buffer liquid 34 comes out. The filling openings 46a, 46b may then be closed with the respective closing elements 48a, 48b. Once the closing elements 48a, 48b are closed, the buffer liquid chamber 32 has a fixed volume.

In the valve 10, the buffer liquid 34 in the buffer liquid chamber 32 constitutes a part of a sealing solution along the shaft 14. The sealing solution of the valve 10 comprising the inner seal arrangement 30 and the buffer liquid 34 prevents process fluid from entering the valve 10. The buffer liquid 34 also serves as a lubricant for the first inner seal 36 and the second inner seal 38 and thereby reduces wear. As a consequence, the lifetime of the valve 10 is increased. The buffer liquid 34 also prevents particles from adhering to the exterior surface 40 of the shaft 14. Thereby, wear of the first inner seal 36 and the second inner seal 38 due to depositions on the shaft 14 is prevented.

The valve 10 further comprises a pilot chamber 50. In FIG. 1, the pilot chamber 50 is arranged in the housing 12. The shaft 14 of this example has a piston 52 fixed to the shaft 14, here integrally formed with the shaft 14. By feeding pressurized pilot fluid 54, such as pilot air, into the pilot chamber 50, the pressure from the pilot fluid 54 acting on the piston 52 generates a driving force on the shaft 14. As shown in FIG. 1, the inner seal arrangement 30 is arranged between the pilot chamber 50 and the buffer liquid chamber 32 along the shaft 14. Moreover, the pilot chamber 50 encloses the shaft 14.

The valve 10 further comprises two compression springs 56, 58. The compression springs 56, 58 encircle the shaft 14 and are provided between the housing 12, more specifically the housing part 12a, and the piston 52. The compression springs 56, 58 are thereby arranged to force the shaft 14 into the illustrated closed position 22 when the pressure in the pilot chamber 50 decreases.

The valve 10 further comprises a piston seal 60. The piston seal 60 provides a seal between the piston 52 and the housing 12, in which the piston 52 is arranged to travel. The piston seal 6o and the first inner seal 36 sealingly close the pilot chamber 50.

The valve 10 further comprises a collection volume 62 between the first inner seal 36 and the second inner seal 38 along the shaft 14. The collection volume 62 is also limited by the housing 12. In the example in FIG. 1, the collection volume 62 encloses the shaft 14.

Any buffer liquid 34 seeping proximally from the buffer liquid chamber 32 past the second inner seal 38, and any pilot fluid 54 seeping distally from the pilot chamber 50 past the first inner seal 36, is collected in the collection volume 62 and discharged. In case any process fluid seeps proximally past the outer seal arrangement 28, through the buffer liquid chamber 32, and past the second inner seal 38, such process fluid will also be collected in the collection volume 62 and discharged.

The valve 10 further comprises a ventilating passage 64. The ventilating passage 64 is arranged to ventilate the collection volume 62. In the example of FIG. 1, the ventilating passage 64 comprises a shaft passage 66 in the shaft 14 that extends longitudinally to the end 20 of the shaft 14. The shaft passage 66 also extends radially by means of two radial sections 68 through the exterior surface 4o of the shaft 14 and into the collection volume 62. Since the shaft passage 66 extends to the end 20 of the shaft 14, which is at atmospheric pressure, also the collection volume 62 is at atmospheric pressure. The collection volume 62 between the first inner seal 36 and the second inner seal 38 is thereby ventilated through the ventilating passage 64. Thus, it can be ensured that the pressure between the first inner seal 36 and the second inner seal 38 never exceeds atmospheric pressure. Thereby, pressure buildup between the first inner seal 36 and the second inner seal 38 can be prevented during operation of the valve 10.

The valve 10 of the example in FIG. 1 further comprises a distance element 70. The distance element 70 is rigid, here exemplified as a bushing. The first inner seal 36 and the second inner seal 38 are secured to the distance element 70. Thereby, the distance element 70 maintains a distance between the first inner seal 36 and the second inner seal 38. The distance element 70 comprises a plurality of distance element openings 72. Thereby, the distance element 70 does not fluidly separate the collection volume 62.

The valve 10 in FIG. 1 is particularly suitable for use in applications where the performance of dynamic radial seals is critical and where the dynamic radial seals alone are not sufficient to reach a desired lifetime and/or performance.

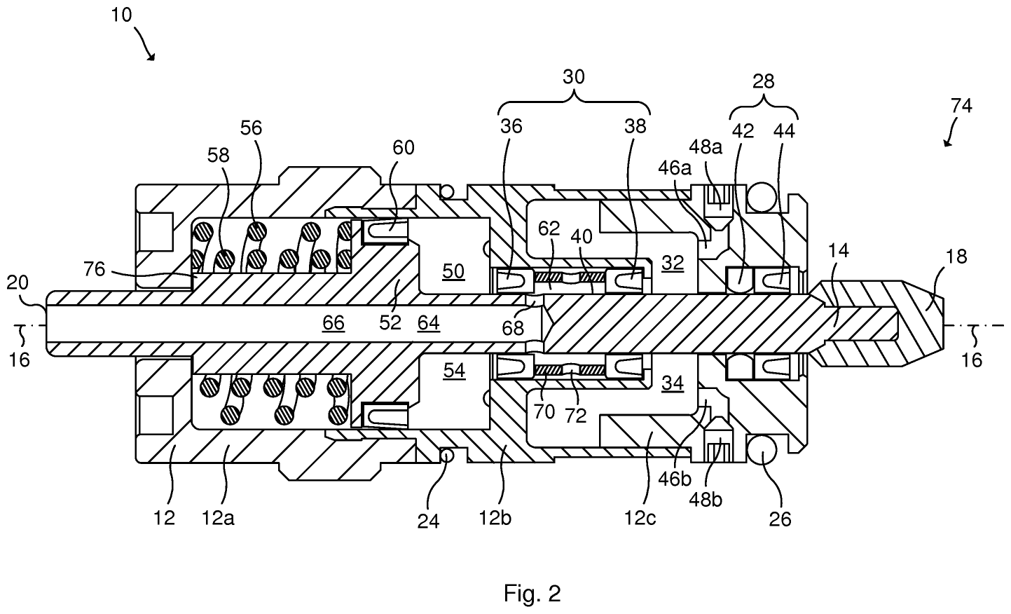

FIG. 2 schematically represents a cross-sectional side view of the valve 10 in FIG. 1 in an open position 74. By introducing pressurized pilot fluid 54 into the pilot chamber 50, the pressure in the pilot chamber 50 is increased and a force is thereby generated on the piston 52. This force on the piston 52 causes the shaft 14 to move from the closed position 22 to the open position 74, e.g. when a stop 76 of the shaft 14 abuts against the housing part 12a.

In the open position 74, the shaft 14 is configured to open a process fluid passage by means of the closing member 18. The closing member 18, here constituted by a plug member, is configured to be retracted from a valve seat when the shaft 14 and the valve 10 adopt the open position 74.

As shown in FIG. 2, the shaft passage 66 is in fluid communication with the collection volume 62 also in the open position 74 of the shaft 14. Since the axial length of the collection volume 62, i.e. the distance between the first inner seal 36 and the second inner seal 38, is larger than the stroke of the shaft 14 between the closed position 22 and the open position 74, a continuous ventilation of the collection volume 62 during operation of the valve 10 is enabled.

During operation of the valve 10, pilot fluid 54 may enter the collection volume 62 between the first inner seal 36 and the second inner seal 38. However, any pilot fluid 54 in the collection volume 62 will be ventilated by means of the ventilating passage 64. Thereby, any pressure buildup between the first inner seal 36 and the second inner seal 38 can be prevented. In addition, the ventilating passage 64 in combination with the buffer liquid chamber 32 reliably prevent mixing of pilot fluid 54 and process fluid 86.

As shown in FIGS. 1 and 2, the only movable part in connection with the buffer liquid chamber 32 is the shaft 14. However, the volume of the buffer liquid chamber 32 is constant.

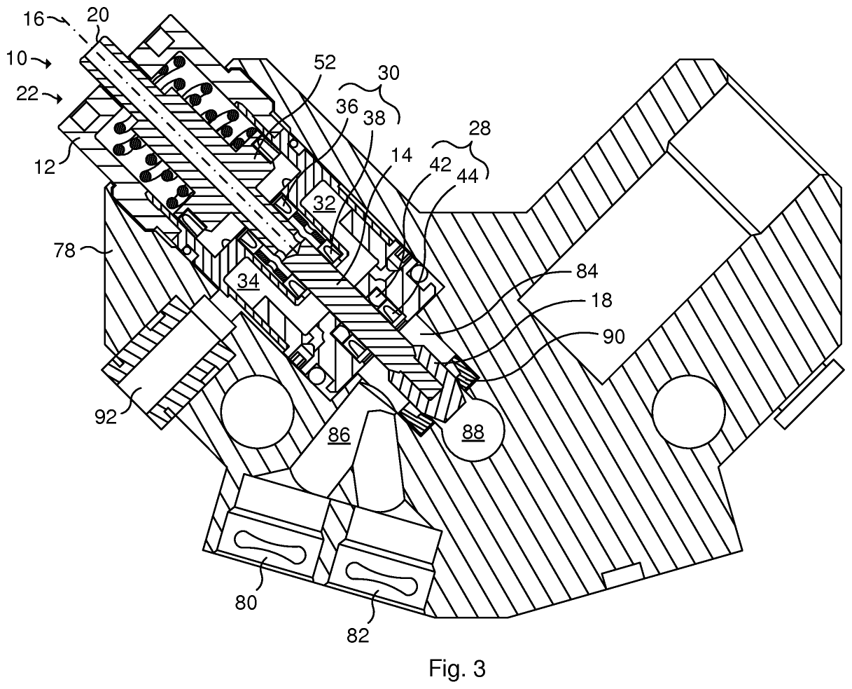

FIG. 3 schematically represents a cross-sectional view of a valve block 78 comprising the valve 10. The valve block 78 may form part of a spraying apparatus (not shown). The valve block 78 may comprise several valves.

The valve 10 is inserted into an opening of the valve block 78 and the housing 12 is secured to the valve block 78. FIG. 3 shows the valve 10 in the closed position 22 according to FIG. 1. As shown in FIG. 3, the exterior O-ring seals 24, 26 seal between the valve 10 and the valve block 78.

The valve block 78 comprises an inlet passage 80, and a return passage 82 in fluid communication with the inlet passage 80. The valve block 78 further comprises a process fluid passage 84 containing process fluid 86, for example process fluid 86 comprising, or being constituted by paint. The valve block 78 further comprises a discharge passage 88 and a valve seat go. During operation, the process fluid 86 may for example have a pressure of 5 bar (500 kPa).

FIG. 3 further shows that the valve block 78 comprises a pilot fluid connection 92. A source of pressurized pilot fluid 54 may be connected to the pilot fluid connection 92 in order to pressurize the pilot chamber 50 of the valve 10.

In case no pilot fluid 54 is supplied into the pilot chamber 50, the compression springs 56, 58 keep the shaft 14 in the closed position 22 where the closing member 18 is seated against the valve seat go. The process fluid 86 from the inlet passage 80 does thereby not enter the discharge passage 88. Instead, the process fluid 86 returns in the return passage 82, e.g. back to a reservoir (not shown).

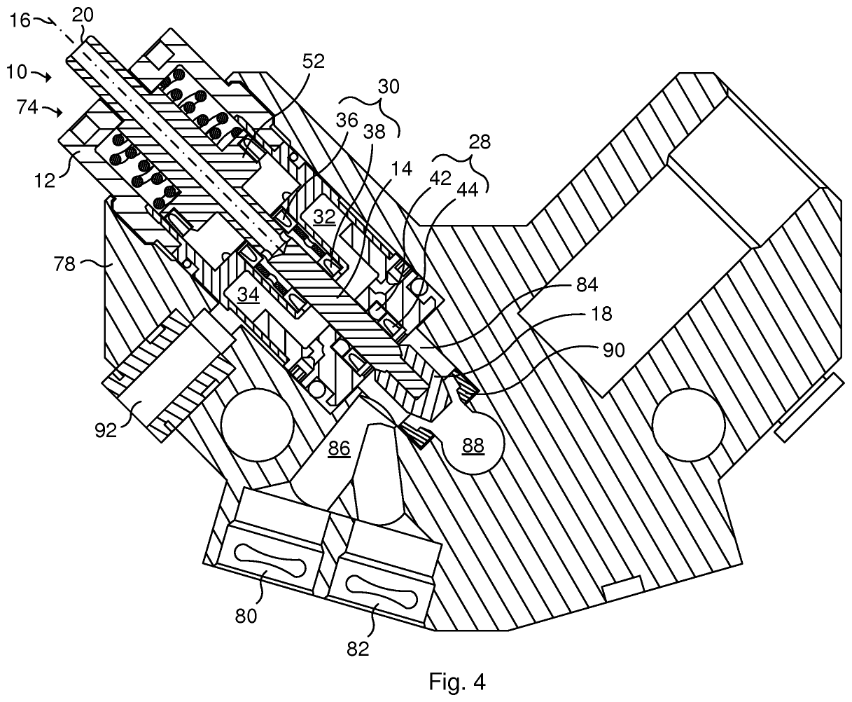

FIG. 4 schematically represents a cross-sectional view of the valve block 78 in FIG. 3 when the valve 10 is in the open position 74. By applying pilot fluid 54 into the pilot chamber 50, the shaft 14 moves from the closed position 22 to the open position 74 and the closing member 18 separates from the valve seat go. The process fluid 86 now flows from the inlet passage 80, through the process fluid passage 84, past the valve seat 90, and into the discharge passage 88. Due to the valve 10 comprising the buffer liquid chamber 32 containing buffer liquid 34, the buffer liquid 34 prevents both leakage of process fluid 86 along the shaft 14, and deposition of hardened particles on the shaft 14.

While the present disclosure has been described with reference to exemplary embodiments, it will be appreciated that the present invention is not limited to what has been described above. For example, it will be appreciated that the dimensions of the parts may be varied as needed.

1. A valve for controlling a flow of process fluid, the valve comprising:
a housing;
a shaft having a closing member, the shaft being received in the housing, and arranged to move axially relative to the housing between a closed position for closing a process fluid passage by means of the closing member, and an open position for opening the process fluid passage by means of the closing member;
an outer seal arrangement for preventing process fluid from entering the housing, the outer seal arrangement including at least one dynamic radial outer seal enclosing the shaft;
an inner seal arrangement, axially spaced from the outer seal arrangement along the shaft, the inner seal arrangement including at least one dynamic radial inner seal enclosing the shaft; and
a buffer liquid chamber containing buffer liquid, the buffer liquid chamber being configured to provide buffer liquid to the shaft, and being arranged between, and sealingly closed by, the outer seal arrangement and the inner seal arrangement.

2. The valve according to claim 1, wherein the buffer liquid chamber has a fixed volume.

3. The valve according to claim 1, wherein the buffer liquid is substantially unpressurized.

4. The valve according to claim 1, further comprising at least one filling opening for filling buffer liquid into the buffer liquid chamber, and an openable closing element for closing the filling opening.

5. The valve according to claim 1, wherein the inner seal arrangement comprises:
a dynamic radial first inner seal enclosing the shaft;
a dynamic radial second inner seal enclosing the shaft, the second inner seal being arranged to sealingly close the buffer liquid chamber; and
a ventilating passage arranged to ventilate a collection volume between the first inner seal and the second inner seal.

6. The valve according to claim 5, wherein the ventilating passage comprises a shaft passage in the shaft.

7. The valve according to claim 6, wherein the shaft passage extends longitudinally to an end of the shaft.

8. The valve according to claim 6, wherein the shaft passage extends radially through an exterior surface of the shaft.

9. The valve according to claim 8, wherein the shaft passage is arranged to be in fluid communication with the collection volume in the closed position, in the open position, and in any intermediate position, of the shaft.

10. The valve according to claim 5, wherein the ventilating passage is at atmospheric pressure during operation of the valve.

11. The valve according to claim 5, further comprising a distance element arranged to maintain a distance between the first inner seal and the second inner seal.

12. The valve according to claim 5, wherein the collection volume is defined between the first inner seal and the second inner seal.

13. The valve according to claim 1, further comprising a pilot chamber in the housing, the pilot chamber being arranged to receive pressurized pilot fluid to drive the shaft.

14. The valve according to claim 13, further comprising a piston fixed to the shaft and a piston seal, wherein the pilot chamber is sealingly closed by the inner seal arrangement and the piston seal.

15. The valve according to claim 1, wherein the buffer liquid comprises a solvent for the process fluid.

16. The valve according to claim 1, wherein the valve is configured to control a flow of process fluid including paint.

17. The valve according to claim 2, wherein the buffer liquid is substantially unpressurized.

18. The valve according to claim 7, wherein the shaft passage extends radially through an exterior surface of the shaft.
